(19) United States
(12) Patent Application Publication
(10) Pub. No.: US 2007/0174167 A1
(43) Pub. Date: Jul. 26, 2007

(54) Derivative relationship news event reporting

(76) Inventors: Stefano Natella, New York, NY (US); Ashley Van der Waag, New York, NY (US); Andrew Martin, Hanover, NH (US)

Correspondence Address: KING & SPALDING;CREDIT SUISSE SECURITIES (USA) LLC, 1180 PEACHTREE STREET, NE, 34TH FLOOR, ATLANTA, GA, 30309-3521, US

(21) Appl. No.: 11/224,431

(22) Filed: Sep. 12, 2005

Related U.S. Application Data
(60) Provisional application No. 60/682,920, filed on May 20, 2005.

(51) Int. Cl. G06Q 40/00

(52) U.S. Cl. 705/36 R

(57) ABSTRACT

Presenting news events relevant to derivative entities of a main subject by associating derivative entities with the main subject based on a direct relationship with the main subject, filtering news events to identify main news events relevant to the main subject, identifying the derivative entities associated with the main subject, filtering news events to identify derivative news events relevant to the derivative entities, and presenting the main news events and the derivative news events. The direct relationship between the derivative entities and the main subject comprises one of supplier, customer, competitor, partner, joint venturer, and equity investor. Presenting the news events also can comprise filtering the derivative news events to identify filtered derivative news events based on specified criteria, where the presented derivative news events comprise only the filtered derivative news events. An investment opportunity can be identified based on the presented main news events and/or derivative news events.

### RELATED PATENT APPLICATION

This application claims priority under 35 U.S.C. § 119 to U.S. Provisional Patent Application No. 60/682,920 filed May 20, 2005 and entitled “Derivative Relationship News Event Reporting.” The subject matter of the above-identified priority application is hereby fully incorporated herein by reference.

### FIELD OF THE INVENTION

The present invention relates to reporting news events for specified entities. More particularly, the present invention relates to reporting news events for a main subject and for entities having a derivative relationship with the main subject.

### BACKGROUND OF THE INVENTION

“News events” comprise news reports, research articles, research reports, trading recommendations and commentary, press releases, SEC filings, financial information, trading data, and any other information that is relevant to a company. When important news events break in the market, interested parties need to react quickly to optimize the benefit of the news events' information. Conventional systems have been developed to filter news events for information that is relevant to a “main subject” entity discussed within each news event. An interested party can select a particular main subject, and the conventional systems can identify and present news events that are relevant to the particular main subject. Then, the interested party can make or present investment decisions or opportunities based on the news events reported for the particular main subject.

Although news events generally are relevant to a main subject discussed therein, those news events also can be relevant to derivative entities that have one or more direct relationships to the main subject. Additionally, news events for such a derivative entity can be relevant to the main subject. For example, a first level derivative entity can be a supplier, customer, competitor, partner or joint venturer, equity investor, or other entity having a direct relationship with the main subject. A second level derivative entity can have one of those relationships with a first level derivative entity. News events that affect the main subject can have a delayed effect on the derivative entities, and news events that affect the derivative entities can have a delayed effect on the main subject. However, conventional news event reporting systems cannot identify and present news events relevant to the derivative entities of the particular main subject in response to a request for news events relevant to the particular main subject. Additionally, the relationship between the main subject and a derivative entity may not be intuitive, which can make it more difficult to identify news events relevant to a derivative entity in response to a request for news events relevant to a main subject.

Accordingly, a need exists in the art for enabling interested parties to react quickly to a main subject's news events that impact derivative entities, particularly where the relationship between the main subject and a derivative entity is not intuitive. A need also exists for identifying the derivative relationships in response to a news event that is relevant to the main subject and for reporting news events relevant to those derivative entities. A further need exists for presenting news events for multiple levels of derivative entities related to a main subject. Yet another need exists for identifying an investment opportunity regarding a main subject and/or a derivative entity based on the presented news events.

### SUMMARY OF THE INVENTION

The present invention combines a news reporting service with a derivative relationship database. The database defines derivative relationships between a main subject and one or more levels of derivative entities related to the main subject. For example, a first level derivative entity can be a supplier, customer, competitor, partner or joint venturer, equity investor, or other entity having a direct relationship with the main subject. A second level derivative entity can have one of those relationships with a first level derivative entity. An end user requests news events relevant to the main subject and receives the news events via a workstation, such as a client computer. Additionally, the derivative entities related to the main subject are identified from the database, and the end user also can receive news events relevant to the derivative entities via the work station.

When a news event related to the main subject breaks, derivative entities can be identified quickly based on the relationships stored in the database, and the end user can receive headlines of news events relevant to the main subject and the derivative entities. Using that information, analysts, researchers, salespeople, traders, corporate investor relations members, corporate market intelligence group members, corporate treasury department members, and other interested parties can determine who else might be affected by the news events/headlines and can evaluate stock prices accordingly. Thus, the present invention can enable interested parties to react quickly to a derivative entity's news events that may impact the main subject or to the main subject's news events that may impact derivative entities, particularly where the relationship between the main subject and a derivative entity is not intuitive. The present invention can identify the derivative relationships in response to a news event that is relevant to the main subject or a derivative entity, or in response to an identification of the main subject or a derivative entity, and can report news events relevant to the main subject and those derivative entities to interested parties, thereby enabling those interested parties to react quickly to information that may affect the main subject and/or its derivative entities. Then, the interested parties can identify an investment opportunity regarding the main subject and/or a derivative entity based on the presented news events related to the main subject and/or the news events related to the derivative entity.

One aspect of the present invention relates to presenting news events related to derivative entities of a main subject. Derivative entities can be associated with the main subject based on a direct relationship with the main subject. News events can be filtered to identify main news events related to the main subject. The derivative entities associated with the main subject can be identified, and news events can be filtered to identify derivative news events related to the derivative entities. Then, the main news events and the derivative news events can be presented. The direct relationship between the derivative entities and the main subject can comprise one of supplier, customer, competitor, partner, joint venturer, and equity investor. The derivative news events can be filtered to identify filtered derivative news events based on one of the relationship between the derivative entities and the main subject, an importance of the relationship between the derivative entities and the main subject, and a percentage of the main subject's sales that is attributable to the derivative entities, where the presented derivative news events comprise only the filtered derivative news events. A second level derivative entity can be associated with one of the derivative entities based on a direct relationship between the second level derivative entity and the related derivative entity, and second level news events related to the second level derivative entity also can be presented. An investment opportunity can be identified based on the presented main news events, derivative news events, and/or second level news events.

Another aspect of the present invention relates to presenting news events related to derivative entities of a main subject. At least one derivative entity can be associated with the main subject based on a direct relationship between the at least one derivative entity and the main subject. Main news events related to the main subject can be received. The at least one derivative entity associated with the main subject can be identified, and derivative news events related to the at least one derivative entity can be received. Then, the main news events and the derivative news events can be presented. The direct relationship between the at least one derivative entity and the main subject can comprise one of supplier, customer, competitor, partner, joint venturer, and equity investor.

Yet another aspect of the present invention relates to a system for presenting news events related to derivative entities of a main subject. A relationship database associates first level derivative entities with the main subject based on a direct relationship between each of the first level derivative entities and the main subject. A workstation communicates a query to receive main news events related to the main subject and receives the main news events communicated in response to the query. A server identifies the first level derivative entities associated with the main subject in the relationship database. The workstation also receives derivative news events related to the first level derivative entities identified by the server and presents the received derivative news events simultaneously with the received main news events. The direct relationship between each of the first level derivative entities and the main subject comprises one of supplier, customer, competitor, partner, joint venturer, and equity investor. The system also can include a news service provider that receives the query from the workstation, filters non-specific news events to identify the main subject news events in response to receiving the query, and communicates the main subject news events to the workstation. The news service provider also can filter the non-specific news events to identify the derivative news events and can communicate the derivative news events to the workstation.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a block diagram depicting a system for providing derivative relationship news event reporting according to an exemplary embodiment of the present invention.

FIG. 2 is a flow chart depicting a method for derivative relationship news event reporting according to an exemplary embodiment of the present invention.

FIG. 3 is a flow chart depicting a method for developing a derivative relationship database according to an exemplary embodiment of the present invention.

FIG. 4 is a flow chart depicting a method for presenting news events relevant to the main subject according to an exemplary embodiment of the present invention.

FIG. 5 is a flow chart depicting a method for presenting news events relevant to entities having a derivative relationship with the main subject according to an exemplary embodiment of the present invention.

FIG. 6 is a flow chart depicting a method for filtering news events relevant to derivative entities related to the main subject according to an exemplary embodiment of the present invention.

FIGS. 7A-7C illustrate a representative user interface for inputting main subject and derivative entity relationships and corresponding information within a database structure of a relationship database according to an exemplary embodiment of the present invention.

FIGS. 8A-8C comprise tables that illustrate exemplary values that can be assigned to data for input into the derivative relationship database according to an exemplary embodiment of the present invention.

FIG. 9 illustrates an exemplary relationship map spreadsheet that shows the database record for a main subject and multiple derivative entities according to an exemplary embodiment of the present invention.

FIG. 10 illustrates an exemplary XML schema for associating a main subject with multiple derivative entities according to an exemplary embodiment of the present invention.

FIG. 11 illustrates a representative end user interface for presenting news events relevant to a main subject and derivative entities related to the main subject according to an exemplary embodiment of the present invention.

### DETAILED DESCRIPTION OF EXEMPLARY EMBODIMENTS

The present invention combines a news reporting service with a derivative relationship database. The database defines derivative relationships between a main subject and one or more levels of derivative entities related to the main subject. For example, a first level derivative entity can be a supplier, customer, competitor, partner or joint venturer, equity investor, or other entity having a direct relationship with the main subject. A second level derivative entity can have one of those relationships with a first level derivative entity. An end user requests news events relevant to the main subject and receives the news events via a workstation, such as a client computer. Additionally, the derivative entities related to the main subject are identified from the database, and the end user also can receive news events relevant to the derivative entities via the work station.

When a news event related to the main subject breaks, derivative entities can be identified quickly based on the relationships stored in the database, and the end user can receive headlines of news events relevant to the main subject and the derivative entities. Using that information, analysts, researchers, salespeople, traders, corporate investor relations members, corporate market intelligence group members, corporate treasury department members, and other interested parties can determine who else might be affected by the news events and can evaluate stock prices accordingly. Thus, the present invention can enable interested parties to react quickly to a derivative entity's news events that may impact a main subject or to a main subject's news events that may impact derivative entities, particularly where the relationship between the main subject and a derivative entity is not intuitive. The present invention can identify the derivative relationships in response to a news event that is relevant to the main subject or a derivative entity, or in response to an identification of the main subject or a derivative entity, and can report news events relevant to those derivative entities to interested parties, thereby enabling those interested parties to react quickly to information that may affect the main subject and/or its derivative entities. Then, the interested parties can identify an investment opportunity regarding the main subject and/or a derivative entity based on the presented news events related to the main subject and/or the presented news events related to the derivative entity.

The present invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Referring to the drawings, in which like numerals represent like elements, aspects of the exemplary embodiments will be described.

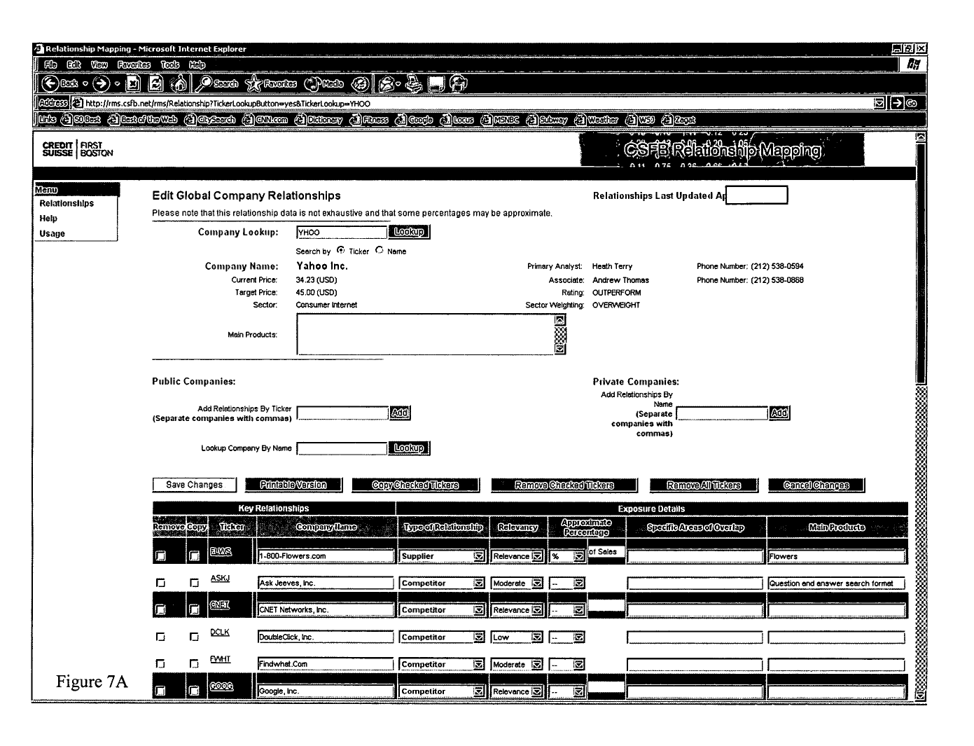

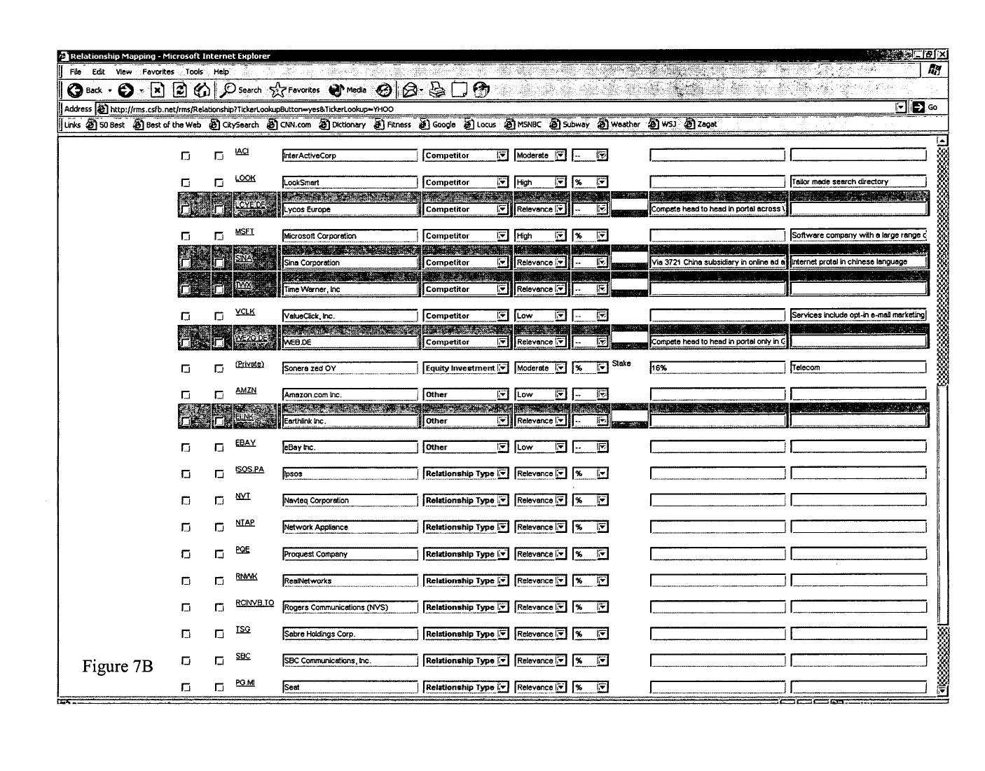

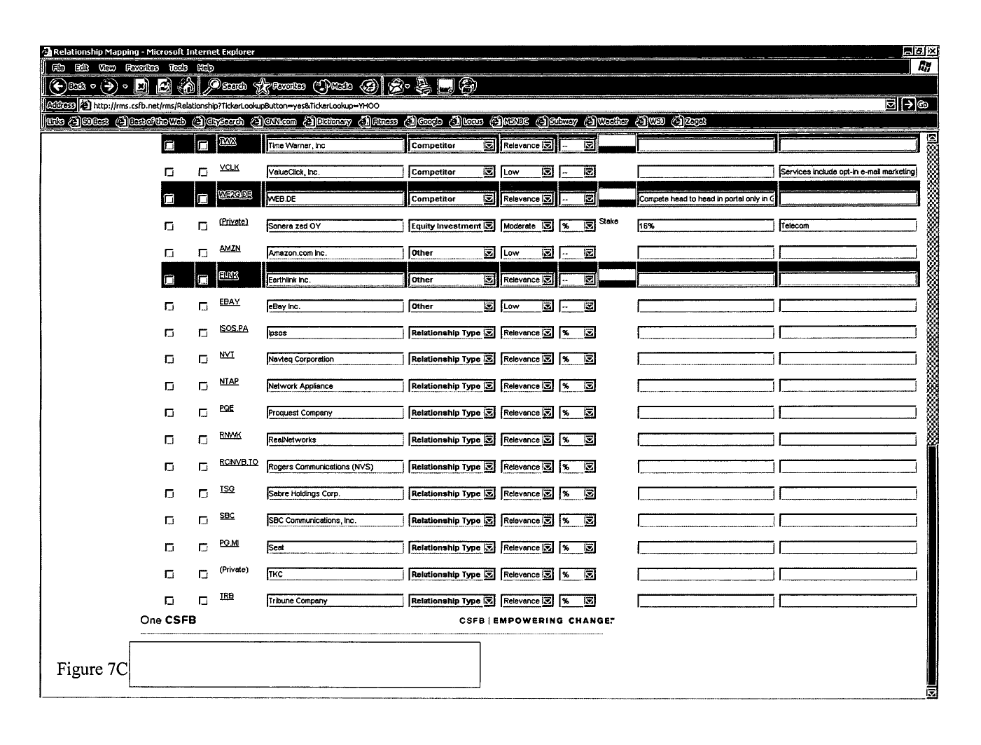

In an exemplary embodiment, a user, such as an investment analyst, develops a derivative relationship database that associates a main subject with one or more levels of related “derivative” entities. FIGS. 7A-7C illustrate a representative user interface for inputting main subject and derivative entity relationships and corresponding information within a database structure of a relationship database according to an exemplary embodiment of the present invention. The representative user interface continues from FIG. 7A to FIG. 7B to FIG. 7C. As illustrated, an analyst can input a main subject in the “Company Lookup” control field based on either the company's ticker symbol or name. The analyst can select either the “Ticker” or “Name” radio button to indicate the format used to input the main subject. Then, the analyst can input relationships between the main subject and public company derivative entities by inputting a derivative entity identification in the “Add Relationships By Ticker” control field or the “Lookup Company By Name” control field. The analyst also can input relationships between the main subject and private company derivative entities by inputting a derivative entity identification in the “Add Relationships By Name” control field. After inputting a main subject and a derivative entity, the derivative relationship database associates the derivative entity with the main subject.

After inputting a related entity's identification, the derivative entity is displayed in the “Key Relationships” portion of the user interface. The analyst can identify the type of relationship between the derivative entity and the main subject by selecting a relationship from the “Type of Relationship” control field. Then, the derivative relationship database associates the type of derivative entity relationship with the main subject. In an exemplary embodiment, the derivative entities can have one of the following direct relationships with the main subject or with an entity in a higher derivative level: supplier, customer, competitor, partner or joint venturer, equity investor, or other relationships.

The analyst also can identify the relevancy or importance of the relationship between the derivative entity and the main subject by selecting an importance rating from the “Relevancy” control field. Then, the derivative relationship database associates the importance of the derivative entity relationship with the main subject. In an exemplary embodiment, the importance rating can indicate the relative importance of each derivative entity to the business of the main subject. For example, each derivative entity can be associated with an importance rating of high, moderate, or low, indicating the importance of the respective first level derivative entities to the business of the main subject.

The analyst also can identify the approximate percentage of the main subject's sales that are attributable to the derivative entity by selecting a percentage from the “Approximate Percentage” control field. Then, the derivative relationship database associates the main subject's percent of sales attributable to the derivative entity with the main subject. As used herein, “sales” can comprise net or gross sales receipts, revenues, earnings, profits, proceeds, or other suitable income metric attributable to the derivative entity.

The analyst can repeat the data entry process for each company that has a relationship with the main subject. Additionally, the data entry process can be completed for second level and higher derivative relationships by inputting direct relationships between derivative entities. For example, a second level derivative entity can be a supplier to a first level derivative entity which is a direct supplier to the main subject. Alternatively, the database can associate the second level and higher derivative entities to a main subject based on relationships that are stored in the database. For instance, a supplier or other related entity associated with a first level derivative entity of a main subject can be associated with the main subject as a second level derivative entity. The data entry process also can be repeated for multiple main subjects.

After entry of the relationship information, the database records comprise the main subjects associated with their related derivative entities and the information that defines the relationship between the companies.

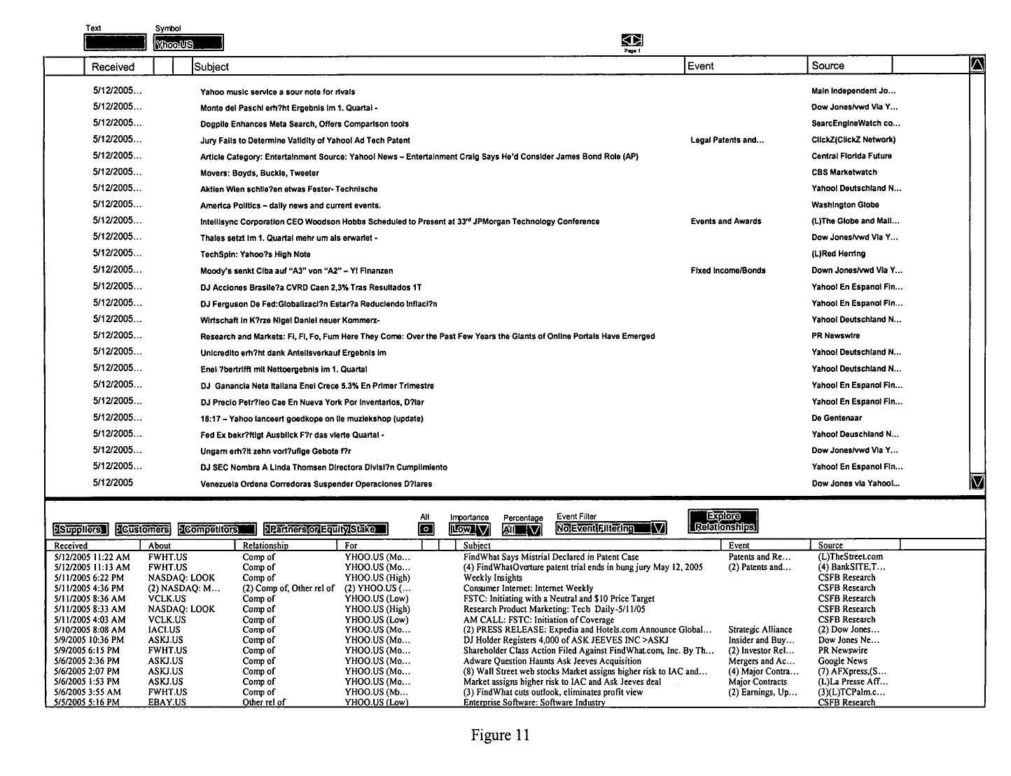

After the database is developed, an end user can request and receive news events related to the main subject and the derivative entities. FIG. 11 illustrates a representative end user interface for presenting news events relevant to a main subject and derivative entities related to the main subject according to an exemplary embodiment of the present invention. As illustrated, the end user can input the main subject's ticker symbol or other identification in the “Symbol” control field on the upper portion of the end user interface. A news service filters news events to identify news events relevant to the main subject, and the end user interface presents the news events relevant to the main subject in its upper portion.

Additionally, the end user interface can present news events that are relevant to the entities related to the main subject. The derivative relationship database can be searched to identify derivative entities that are associated with the main subject. Then, the news service filters news events to identify news events relevant to the derivative entities, and the end user interface presents those relevant news events in its lower portion. The end user can filter the presented derivative entity news events based on the criteria illustrated in the lower portion of the end user interface. For example, the end user can filter the news events by selecting one or more of the “Suppliers,” “Customers,” “Competitors,” and “Partners or Equity Stake” controls. The end user also can filter the news events by selecting one or more of an importance rating, a percentage of sales, or a specified type of event. The end user interface can present the news events that meet all of the criteria selected by the end user.

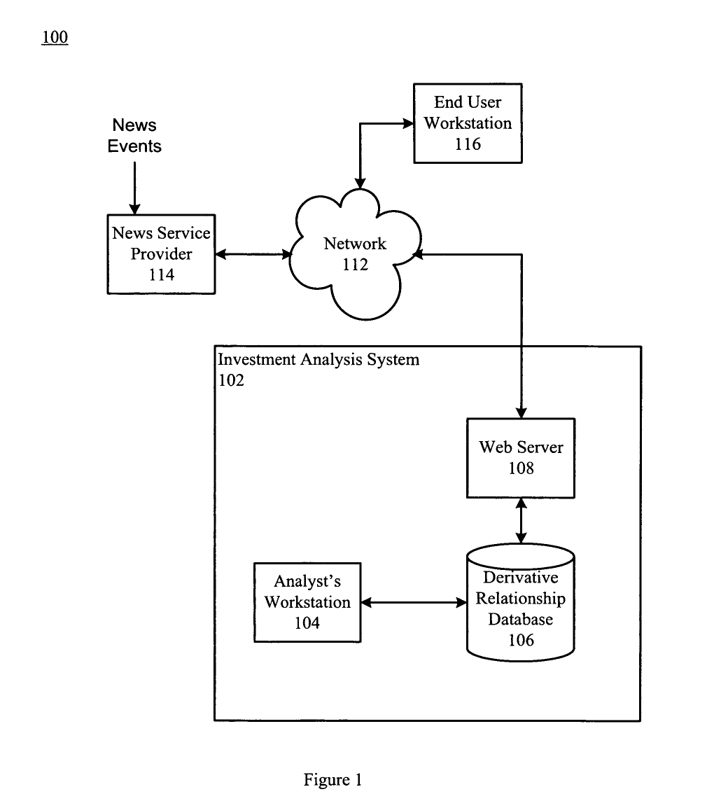

FIG. 1 is a block diagram depicting a system 100 for providing derivative relationship news event reporting according to an exemplary embodiment of the present invention. As illustrated, the system 100 comprises a news service provider 114 coupled to an investment analysis system 102 via a network 112. In exemplary embodiments, the network 112 can comprise the Internet, a local area network, a direct communication line, or other suitable network.

The investment analysis system 102 comprises an analyst's workstation 104, a web server 108, and a derivative relationship database 106. The derivative relationship database 106 stores records for multiple main subjects related to one or more levels of derivative entities.

To build the derivative relationship database 106, a user, such as an investment analyst, inputs a main subject via the analyst's workstation 104 into the database 106. Then, the analyst identifies and inputs derivative entities that are related to the main subject into the database 106 via the analyst's workstation 104, and the database 106 relates the derivative entities to the main subject. In an exemplary embodiment, the derivative entities can have one of the following relationships with the main subject or with an entity in a higher derivative level: supplier, customer, competitor, partner or joint venturer, equity investor, or other relationships. The analyst can repeat the database development process to create a database 106 comprising multiple main subjects and their respective derivative relationships.

Periodically, the database 106 communicates the stored relationships to the web server 108, which stores the relationships for future access related to providing news events.

An end user at an end user workstation 116 can request news events related to one of the main subjects stored in the database 106. In this case, the end user inputs an identifier for the main subject into the end user workstation 116, which communicates the request to the news service provider 114 via the network 112. The workstation 116 can comprise a processor for sending and receiving data via the network 112 and for displaying the information on the display. In exemplary embodiments, the end user can comprise an analyst, researcher, salesperson, trader, corporate investor relations member, corporate market intelligence group member, corporate treasury department member, or another interested party.

“News events” as used herein comprise news reports, research articles, research reports, trading recommendations and commentary, press releases, SEC filings, financial information, trading data, and any other information that is relevant to a company.

The news service provider 114 receives the request for news events relevant to the identified main subject and filters news events to identify such items. The news service provider 114 then communicates the relevant items via the network 112 to the end user workstation 116, which presents the relevant items to the end user. In that regard, the workstation 116 can comprise a monitor or other display device upon which it presents the items relevant to the main subject.

The news service provider 114 generates a query to identify derivative entities related to the main subject and communicates the query to the web server 108 via the network 112. The web server 108 receives the query and identifies those derivative entities based on the main subject's relationships stored in the web server 108. After identifying the derivative entities, the web server 108 communicates a response comprising information identifying the derivative entities and their relationships with the main subject to the news service provider 114 via the network 112.

In an alternative exemplary embodiment, the web server 108 can query the database 106 directly to identify the derivative entities related to the main subject.

The news service provider 114 receives the response identifying the derivative entities related to the main subject and filters news events to identify such items. The news service provider 114 then communicates the relevant items via the network 112 to the end user workstation 116, which presents the relevant items to the end user. In that regard, the workstation 116 can present the items relevant to the derivative entities on the monitor or other display device. In an exemplary embodiment, the workstation 116 can simultaneously present the items relevant to the main subject and the items relevant to the derivative entities in separate portions of a user interface presented on the display, as illustrated in FIG. 11.

In an exemplary embodiment, the end user workstation 116 can present the news events relevant to the main subject and the news events relevant to the derivative entities in a single end user interface. Alternatively, the end user workstation 116 can present the news events relevant to the main subject and the news events relevant to the derivative entities in separate end user interfaces.

The end user can identify an investment opportunity based on the presented news events that are relevant to the main subject and/or the derivative entity or entities. In exemplary embodiments, an investment opportunity can comprise the purchase or sale of a stock, bond, certificate, note, or other security, the purchase or sale of real estate, goods, services, or other property, or any other opportunity to receive a possible return on investment.

In an exemplary embodiment, the end user can identify an investment opportunity for the main subject based on a news event related to one of the derivative entities. For example, if a key semiconductor vendor to IBM reports quality control issues for its semiconductor products, the end user can recognize that this derivative entity news event may have a negative impact on the main subject, IBM. Accordingly, the end user can identify an investment opportunity regarding a sale/purchase of IBM stock. The investment opportunity for this operation of the system is directed to the main subject, IBM, rather than the derivative entity, the vendor. This example illustrates an indirect link for the investment opportunity recommendation, i.e., recommending the purchase or sale of a security in a main subject based on news event information related to a derivative entity.

In an alternative exemplary embodiment, the end user can identify an investment opportunity for a derivative entity based on a news event related to the main subject. For example, the end user can recognize that a news event associated with the main subject may have a negative impact on a derivative entity of the main subject. Accordingly, the end user can identify an investment opportunity regarding a sale/purchase of the derivative entity's stock. The investment opportunity for this operation of the system is directed to the derivative entity rather than the main subject. This example illustrates another indirect link for the investment opportunity recommendation, i.e., recommending the purchase or sale of a security in a derivative entity based on news event information related to the main subject.

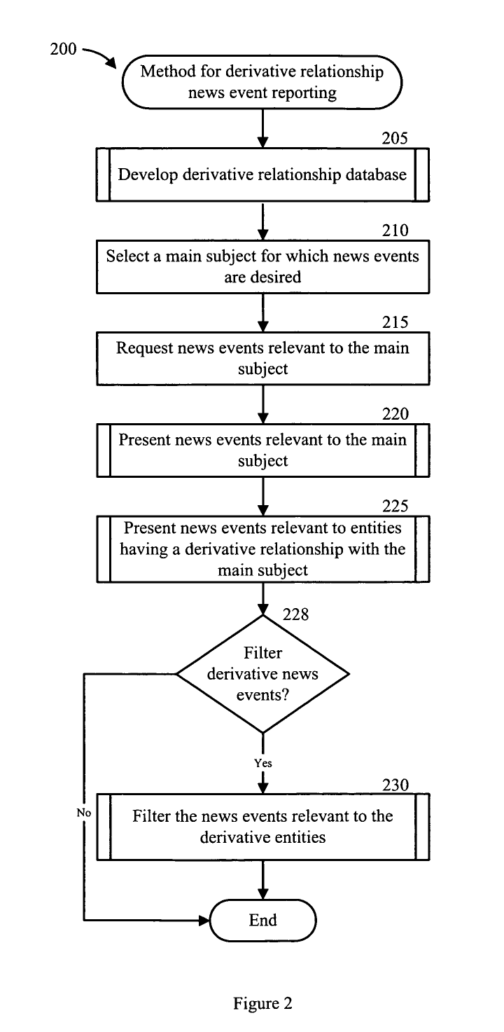

FIG. 2 is a flow chart depicting a method 200 for derivative relationship news event reporting according to an exemplary embodiment of the present invention. The method 200 will be described with reference to FIGS. 1 and 2.

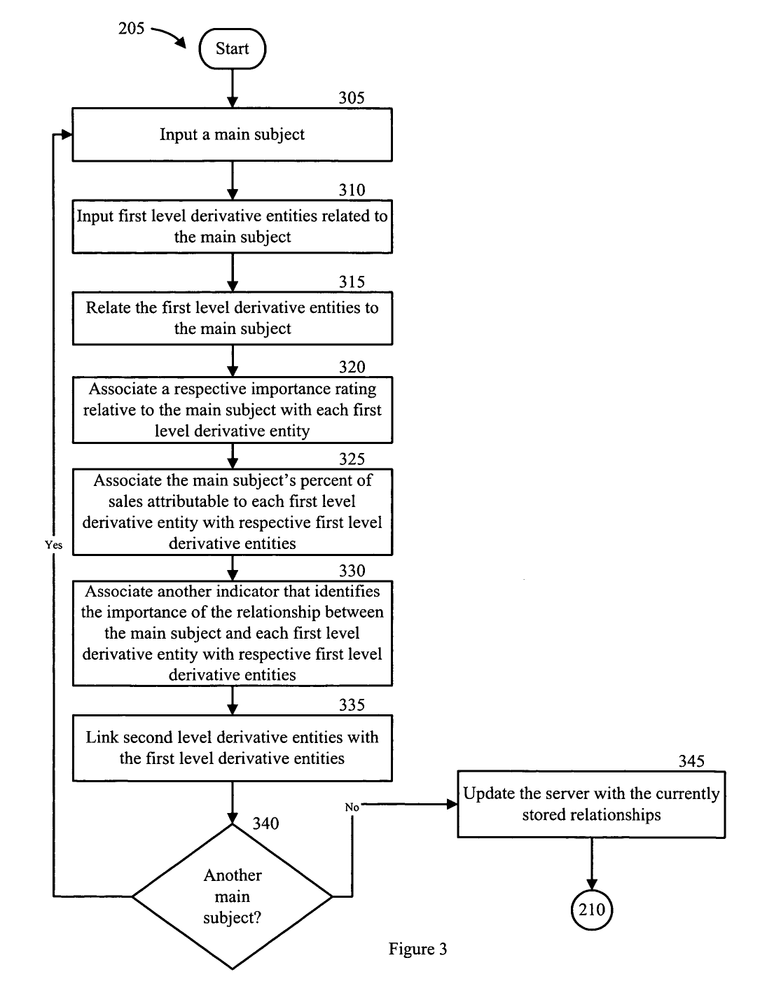

In step 205, a derivative relationship database is developed. Step 205 will be discussed in further detail hereinafter with reference to FIG. 3. In step 210, an end user selects a main subject for which news events are desired by inputting the main subject's identifier into the end user workstation 116. In step 215, the end user requests news events relevant to the main subject by communicating such a request from the end user workstation 116 to the news service provider 114 via the network 112.

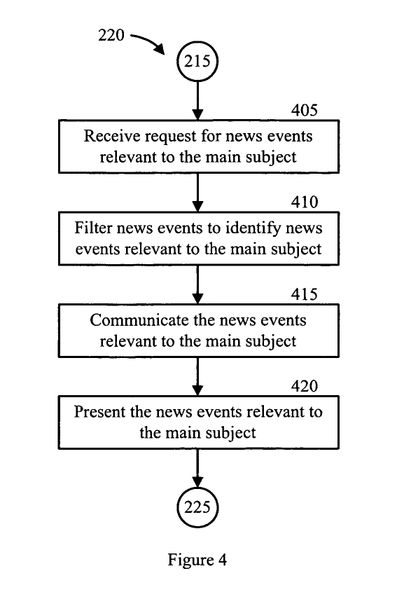

In step 220, the news events relevant to the main subject are presented to the end user via the end user workstation 116. Step 220 will be discussed in further detail hereinafter with reference to FIG. 4.

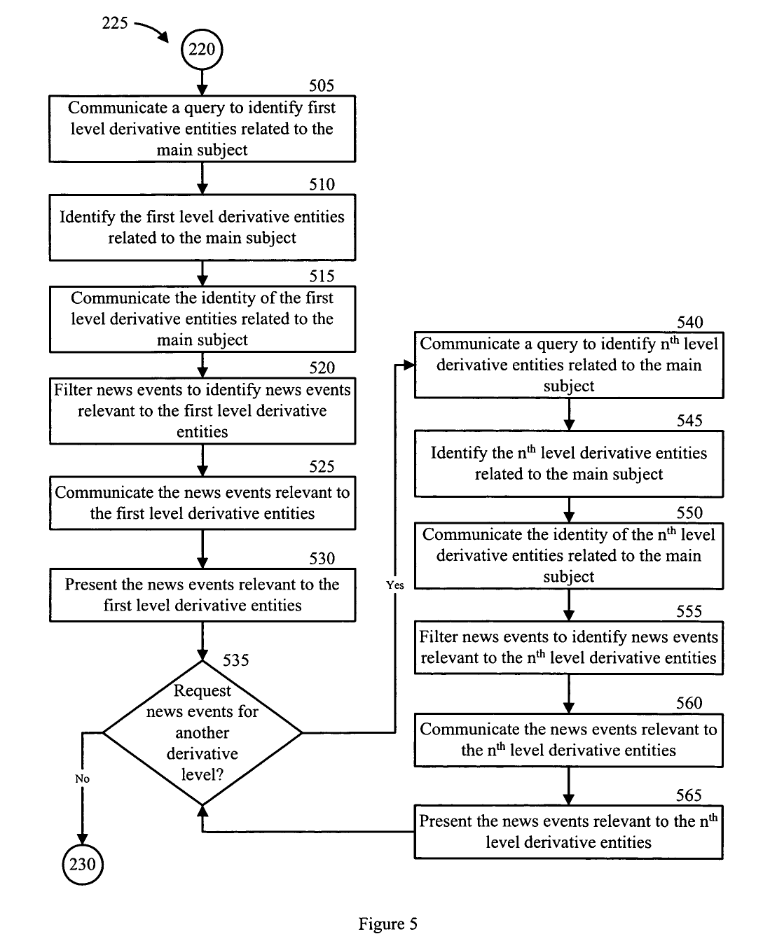

In step 225, news events relevant to entities having a derivative relationship with the main subject are presented to the end user via the end user workstation 116. Step 225 will be discussed in further detail hereinafter with reference to FIG. 5.

Although FIG. 2 illustrates steps 220 and 225 as separate steps in the order shown, in alternative exemplary embodiments, those steps can be performed simultaneously, or step 225 can be performed before step 220.

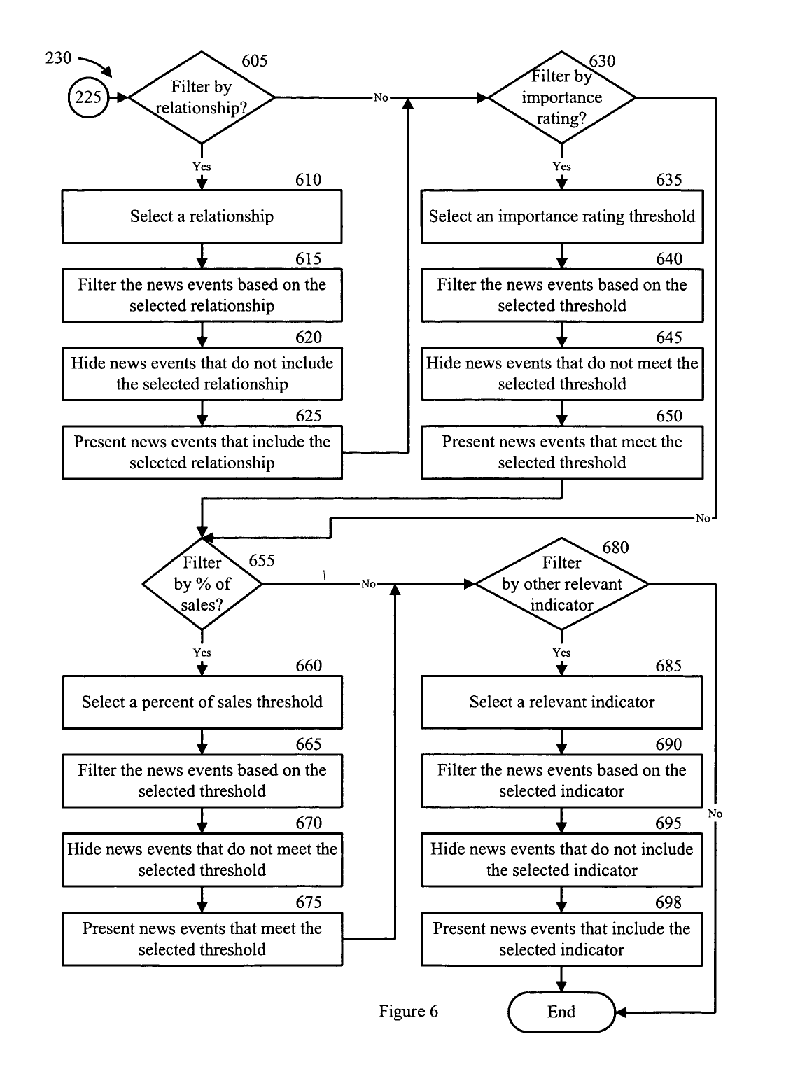

In step 228, the method 200 determines whether to filter the news events relevant to the derivative entities based on the end user's criteria input into the end user workstation 116. If yes, then the method 200 branches to step 230 in which the news events relevant to the derivative entities are filtered to present a subset of the relevant news events. Step 230 will be discussed in further detail hereinafter with reference to FIG. 6. After step 230, the method ends. Referring back to step 228, if the method 200 determines that filtering of the news events is not desired, then the method can branch directly from step 228 to the end.

Although not illustrated in FIG. 2, the news events relevant to the main subject also can be filtered based on criteria input by the end user into the end user workstation 116.

FIG. 3 is a flow chart depicting a method 205 for developing a derivative relationship database according to an exemplary embodiment of the present invention, as referred to in step 205 of FIG. 2. The method 205 will be described with reference to FIGS. 1 and 3.

In step 305, the analyst inputs a main subject into the analyst's workstation 104 by inputting an identifier of the main subject. In exemplary embodiments, the identifier can comprise the name of the company, the stock ticker symbol of the company, or other suitable company identifier. The analyst's workstation 104 communicates the main subject to the database 106 for storing. In step 310, the analyst inputs first level derivative entities related to the main subject into the analyst's workstation 104 by inputting an identifier of each first level derivative entity. The analyst's workstation 104 communicates the first level derivative entities to the database 106 which associates each first level derivative entity with the main subject.

In step 315, the first level derivative entities are related to the main subject based on the relationship between the main subject and respective first level derivative entities. In an exemplary embodiment, the analyst inputs a relationship for each first level derivative entity by selecting an appropriate relationship from a list of relationship choices presented via the analyst's workstation 104. The analyst's workstation 104 then communicates the relationship of each first level derivative entity to the database 106 which associates each relationship with the respective first level derivative entity. According to an exemplary embodiment, the first level derivative entities can have one of the following relationships with the main subject: supplier, customer, competitor, partner or joint venturer, equity investor, or other relationship.

In step 320, an importance rating is associated with each first level derivative entity relative to the main subject. In an exemplary embodiment, the analyst inputs an importance rating for each first level derivative entity by selecting a rating from a list of rating choices presented via the analyst's workstation 104. The analyst's workstation 104 then communicates the importance rating of each first level derivative entity to the database 106 which associates each rating with the respective first level derivative entity. In an exemplary embodiment, the importance rating can indicate the relative importance of each derivative entity to the business of the main subject. For example, each derivative entity can be associated with an importance rating of high, moderate, or low, indicating the importance of the respective first level derivative entities to the business of the main subject. In an alternative exemplary embodiment, the importance rating can comprise a scale value, such as a rating of 1 to 10, which indicates the relative importance of the respective first level derivative entities to the business of the main subject.

In step 325, the main subject's percent of sales attributable to each first level derivative entity is associated with the respective first level derivative entities. In an exemplary embodiment, the analyst inputs a percentage for each first level derivative entity via the analyst's workstation 104. The analyst's workstation 104 then communicates the percentage for each first level derivative entity to the database 106 which associates each percentage with the respective first level derivative entity.

In step 330, another relevant indicator that identifies the importance of the relationship between the main subject and each first level derivative entity can be associated with respective first level derivative entities. In this regard, any suitable indicator can be used to indicate the importance of the relationship between the main subject and the respective first level derivative entities. In an exemplary embodiment, the analyst inputs a relevant indicator for each first level derivative entity via the analyst's workstation 104. The analyst's workstation 104 then communicates the relevant indicator for each first level derivative entity to the database 106 which associates each relevant indicator with the respective first level derivative entity.

In step 335, the database 106 links second level derivative entities with the first level derivative entities. The database 106 can perform that step based on relationships of the first level derivative entities stored in the database 106. For example, the database 106 could include Intel Corporation (“Intel”) as a main subject and identify IBM as a customer of Intel (a first level derivative relationship). The database also could include IBM as a main subject and identify Circuit City as a customer of IBM (another first level derivative relationship). Based on those relationships, the database 106 can associate Circuit City as a second level derivative entity to Intel. In that manner, the database 106 can link multiple levels of derivative entities to a main subject.

In step 340, the method 205 determines whether to input relationships for another main subject. If yes, then the method 205 branches back to step 305 to repeat the relationship input process. If not, then the method branches to step 345.

In step 345, the database 106 communicates the main subject and derivative relationship data to the web server 108 to update the web server 108 with the current information. The web server 108 stores that information for later use in connection with providing news events. The method then proceeds to step 210 (FIG. 2).

Alternative exemplary embodiments can include more or less of the derivative relationships based on alternative database structures. Additionally, alternative exemplary embodiments can include more or less information corresponding to each derivative relationship based on alternative database structures.

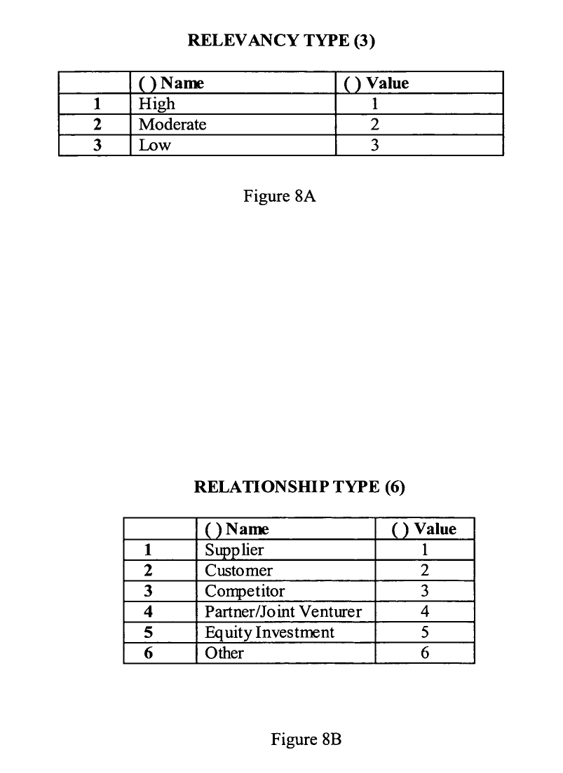

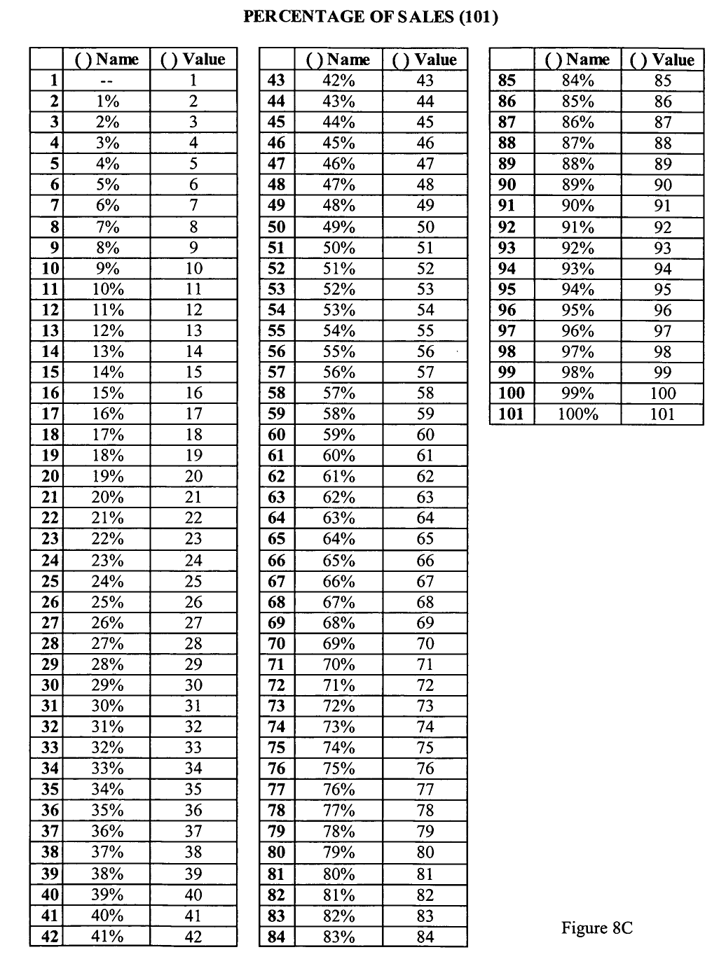

FIGS. 8A-8C comprise three tables that illustrate exemplary values that can be assigned to data for input into the derivative relationship database 106 according to an exemplary embodiment of the present invention. FIG. 8A shows exemplary values of 1, 2, or 3 assigned to relevancy (importance) ratings of high, moderate (medium), or low, respectively. The database 106 can associate one of the values with respective derivative entities to indicate each entity's importance to the business of the main subject.

FIG. 8B shows exemplary values of 1-6 corresponding to direct relationships comprising supplier, customer, competitor, partner/joint venturer, equity investor, or other, respectively. The database 106 can associate one of the values with respective derivative entities to indicate the relationship between each derivative entity and the main subject.

FIG. 8C shows exemplary values of 1-101 corresponding to sales percentages of 0%-100%, respectively. The database 106 can associate one of the values with respective derivative entities to indicate the main subject's percent of sales attributable to respective derivative entities.

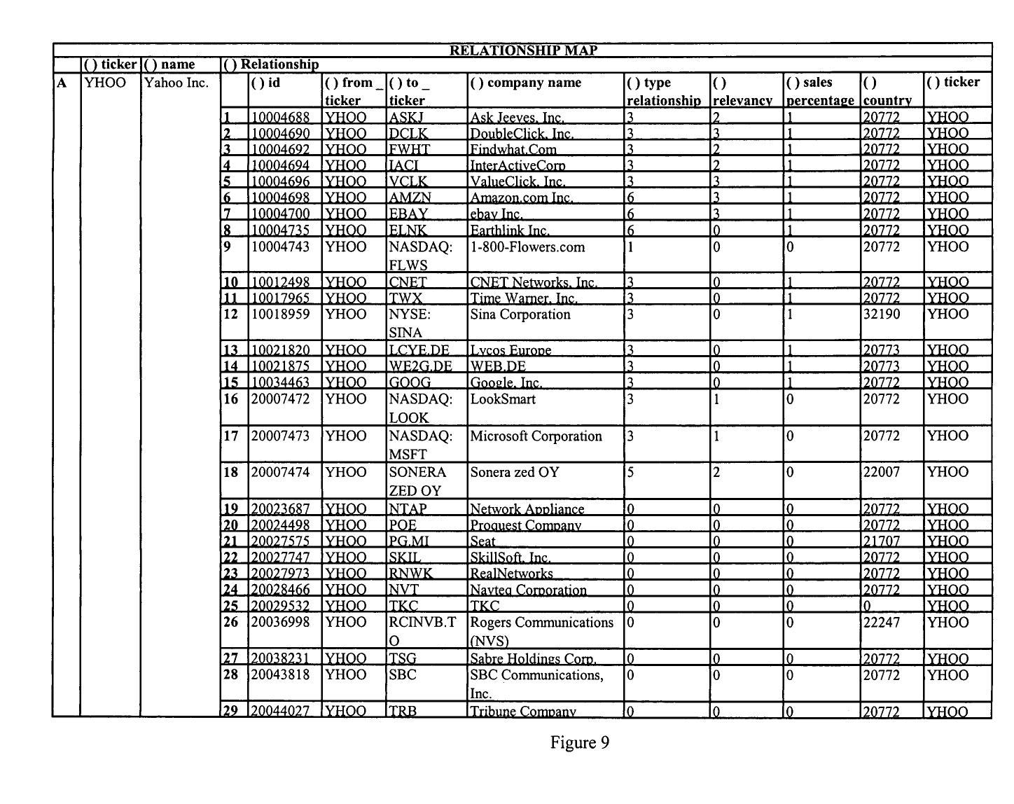

FIG. 9 illustrates an exemplary relationship map spreadsheet that shows the database record for a main subject and multiple derivative entities according to an exemplary embodiment of the present invention. As illustrated, the database record associates the main subject with multiple derivative entities and corresponding information, including, among other things, the type of derivative relationship, relevancy (importance) of each derivative entity to the business of the main subject, and approximate percentage of the main subject's sales attributable to each derivative entity. In the relationship map illustrated in FIG. 9, the values for the importance of the relationship, type of relationship, and percent of sales correspond to the exemplary values illustrated in FIGS. 8A-8C, respectively. A value of “0” indicates that the analyst did not input the information corresponding to the field in which the “0” appears.

As shown in FIG. 9, the exemplary main subject is “Yahoo Inc.,” and twenty-nine derivative entities are associated in the relationship map record to Yahoo Inc. The relationship map record includes the following data that identifies each derivative entity and defines the relationship of that derivative entity with the main subject: (1) the derivative entity identification number, field “id”; (2) the ticker symbol of the main subject that is associated with the derivative entity, field “from_ticker”; (3) the ticker symbol of the derivative entity that is associated with the main subject, field “to_ticker”; (4) the name of the derivative entity, field “name”; (5the type of direct relationship between the main subject and the derivative entity, field “type relationship”; (6) the importance of the derivative entity's relationship to the main subject, field “relevancy”; (7) the percentage of the main subject's sales attributable to the derivative entity, field “sales percentage”; and (8) a country code for the derivative entity, field “country.”

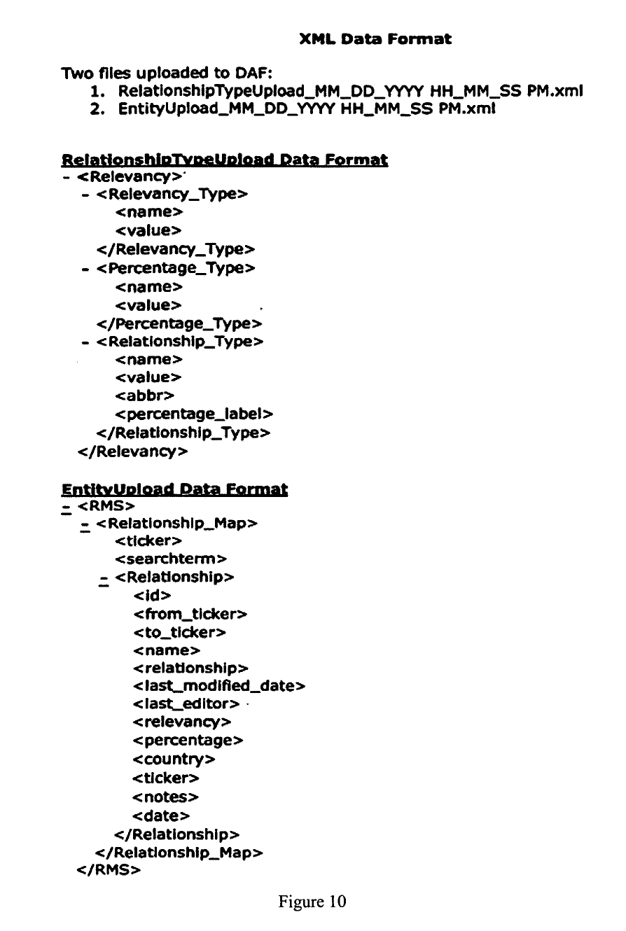

FIG. 10 illustrates an exemplary XML schema for associating a main subject with multiple derivative entities according to an exemplary embodiment of the present invention.

FIG. 4 is a flow chart depicting a method 220 for presenting news events relevant to the main subject according to an exemplary embodiment of the present invention, as referred to in step 220 of FIG. 2. The method 220 will be described with reference to FIGS. 1 and 4.

In step 405, the news service provider 114 receives the request for news events relevant to the main subject. In step 410, the news service provider 114 filters news events to identify news events relevant to the main subject.

In step 415, the news service provider 114 communicates the news events relevant to the main subject to the end user workstation 116 which presents the news events relevant to the main subject to the end user. The end user can filter the news events by inputting filtering criteria via the end user workstation 116. In this case, the end user workstation 116 can present only the news events that meet the specified criteria. The method then proceeds to step 225 (FIG. 2).

FIG. 5 is a flow chart depicting a method 225 for presenting news events relevant to entities having a derivative relationship with the main subject according to an exemplary embodiment of the present invention, as referred to in step 225 of FIG. 2. The method 225 will be described with reference to FIGS. 1 and 5.

In step 505, the news service provider 114 communicates a query via the network 112 to the web sever 108 to identify one or more first level derivative entities related to the main subject. In step 510, the web server 108 searches its memory to identify the first level derivative entities associated with the main subject therein. In an alternative exemplary embodiment, the web server 108 can communicate the query to the database 106 which can identify the first level derivative entities associated with the main subject therein. In step 515, the web server 108 communicates a response comprising the identity of the first level derivative entities related to the main subject and their relationships to the main subject to the news service provider 114 via the network 112.

In step 520, the news service provider 114 receives the response and filters news events to identify news events relevant to the first level derivative entities. Then, in step 525, the news service provider 114 communicates the news events relevant to the first level derivative entities to end user workstation 116 via the network 112. The news service provider 114 also communicates information comprising the relationships between the first level derivative entities and the main subject to the work station 116. In step 530, the end user workstation 116 presents the news events relevant to the first level derivative entities to the end user.

The method then proceeds to step 535. In step 535, the method 225 determines whether to request news events for another level of derivative entities related to the main subject. If yes, then the method branches to step 540. The method 225 can make that determination based on end user input received via the end user workstation 116.

Steps 540-565 describe the process for presenting news events relevant to second level and higher derivative entities. As illustrated in FIG. 5, steps 540-565 describe the process of presenting news events relevant to an nth level derivative entity, which applies to derivative entities at any level.

In step 540, the news service provider 114 communicates a query via the network 112 to the web sever 108 to identify one or more second level derivative entities related to the main subject. In step 545, the web server 108 searches its memory to identify the second level derivative entities associated with the main subject therein. In an alternative exemplary embodiment, the web server 108 can communicate the query to the database 106 which can identify the second level derivative entities associated with the main subject therein. In step 550, the web server 108 communicates a response comprising the identity of the second level derivative entities related to the main subject to the news service provider 114 via the network 112.

In step 555, the news service provider 114 receives the response and filters news events to identify news events relevant to the second level derivative entities. Then, in step 560, the news service provider 114 communicates the news events relevant to the second level derivative entities to the end user workstation 116 via the network 112. In step 565, the end user workstation 116 presents the news events relevant to the second level derivative entities to the end user.

The method then proceeds back to step 535 to determine whether to request news events for another level of derivative entities related to the main subject. If yes, then the method branches back to step 540 to request another level of derivative entity news events. If the method 225 determines in step 535 not to request news events relevant to another level of derivative entities, then the method branches to step 230 (FIG. 2).

FIG. 6 is a flow chart depicting a method 230 for filtering news events relevant to derivative entities related to the main subject according to an exemplary embodiment of the present invention, as referred to in step 230 of FIG. 2. The method 230 will be described with reference to FIGS. 1 and 6.

In step 605, the method 230 determines whether to filter the news events relevant to the derivative entities based on the relationship between the derivative entities and the main subject, or the relationship between an nth level derivative entity and an nth−1 level derivative entity. The method 230 can make that determination based on the input of the end user via the end user workstation 116. For example, the end user can select a particular relationship by which to filter the news events relevant to the derivative entities. In an exemplary embodiment, the relationships from which to choose can comprise supplier, customer, competitor, partner/joint venturer, equity shareholder, or other relationship. If the method 230 determines in step 605 to filter by relationship, then the method branches to step 610.

In step 610, the end user selects a relationship via the end user workstation 116 by which to filter the news events relevant to the derivative entities. In step 615, the end user workstation 116 filters the news events based on the selected relationship by identifying news events for derivative entities that include the selected relationship. In step 620, the end user workstation 116 hides news events for derivative entities that do not include the selected relationship, thereby preventing the end user from viewing those news events via the end user workstation 116. In step 625, the end user workstation 116 presents news events for derivative entities that include the selected relationship.

The method then proceeds to step 630. Referring back to step 605, if the method 230 determined that it will not filter news events relevant to the derivative entities based on relationship, then the method can branch directly to step 630.

In step 630, the method 230 determines whether to filter the news events relevant to the derivative entities based on the importance rating of the derivative entities. The method 230 can make that determination based on the input of the end user via the end user workstation 116. For example, the end user can select a particular importance rating by which to filter the news events relevant to the derivative entities. If the method 230 determines in step 630 to filter by importance rating, then the method branches to step 635.

In step 635, the end user selects an importance rating threshold via the end user workstation 116 by which to filter the news events relevant to the derivative entities. For example, the analyst can select a threshold of low, moderate, or high. In step 640, the end user workstation 116 filters the news events based on the selected threshold by identifying news events for derivative entities that meet the threshold. In step 645, the end user workstation 116 hides news events for derivative entities that do not meet the threshold, thereby preventing the end user from viewing those news events via the end user workstation 116. In step 650, the end user workstation 116 presents news events for derivative entities that meet the threshold.

The method then proceeds to step 655. Referring back to step 630, if the method 230 determined that it will not filter news events relevant to the derivative entities based on importance rating, then the method can branch directly to step 655.

In step 655, the method 230 determines whether to filter the news events relevant to the derivative entities based on the percent of the main subject's sales attributable to the derivative entities. The method 230 can make that determination based on the input of the end user via the end user workstation 116. For example, the end user can select a particular sales percentage by which to filter the news events relevant to the derivative entities. If the method 230 determines in step 655 to filter by sales percentage, then the method branches to step 660.

In step 660, the end user selects a sales percentage threshold via the end user workstation 116 by which to filter the news events relevant to the derivative entities. For example, the analyst can select a percentage between zero and one hundred percent. In step 665, the end user workstation 116 filters the news events based on the selected threshold by identifying news events for derivative entities that meet the threshold. In step 670, the end user workstation 116 hides news events for derivative entities that do not meet the threshold, thereby preventing the end user from viewing those news events via the end user workstation 116. In step 675, the end user workstation 116 presents news events for derivative entities that meet the threshold.

The method then proceeds to step 680. Referring back to step 655, if the method 230 determined that it will not filter news events relevant to the derivative entities based on sales percentage, then the method can branch directly to step 680.

In step 680, the method 230 determines whether to filter the news events relevant to the derivative entities based on another relevant indicator of the relationship between the derivative entities and the main subject. The method 230 can make that determination based on the input of the end user via the end user workstation 116. For example, the end user can select a particular relevant indicator by which to filter the news events relevant to the derivative entities. If the method 230 determines in step 680 to filter by another relevant indicator, then the method branches to step 685.

In step 685, the end user selects a relevant indicator via the end user workstation 116 by which to filter the news events relevant to the derivative entities. In step 690, the end user workstation 116 filters the news events based on the selected relevant indicator by identifying news events for derivative entities that include the selected relevant indicator. In step 695, the end user workstation 116 hides news events for derivative entities that do not include the selected relevant indicator, thereby preventing the end user from viewing those news events via the end user workstation 116. In step 698, the end user workstation 116 presents news events for derivative entities that include the selected relevant indicator.

The method then ends. Referring back to step 680, if the method 230 determined that it will not filter news events relevant to the derivative entities based on another relevant indicator, then the method can branch directly to the end.

FIG. 6 illustrates an exemplary interaction between the various methods of filtering the news events. In exemplary embodiments, the news events can be filtered based on one or more of the criteria illustrated in FIG. 6, and the news events can be filtered by those criteria in any desired order.

The present invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed is:

1. A computer-implemented method for presenting derivative news events relevant to derivative entities of a main subject, comprising the steps of:
associating at least one derivative entity with the main subject based on a direct relationship between the at least one derivative entity and the main subject;
identifying the at least one derivative entity associated with the main subject;
filtering news events to identify one or more derivative news events relevant to the at least one derivative entity; and
presenting the derivative news events.

2. The method of claim 1, wherein the direct relationship between the at least one derivative entity and the main subject comprises one of supplier, customer, competitor, partner, joint venturer, and equity investor.

3. The method of claim 1, further comprising the step of filtering the derivative news events to identify filtered derivative news events based on one of the relationship between the at least one derivative entity and the main subject, an importance of the relationship between the at least one derivative entity and the main subject, and a percentage of the main subject's sales that is attributable to the at least one derivative entity,
wherein the derivative news events presented in said presenting step comprise only the filtered derivative news events.

4. The method of claim 1, further comprising the step of identifying an investment opportunity based on the presented derivative news events.

5. The method of claim 1, further comprising the steps of:
associating a second level derivative entity with the at least one derivative entity based on a direct relationship between the second level derivative entity and the at least one derivative entity; and
filtering news events to identify second level news events relevant to the second level derivative entity,
wherein said presenting step further comprises presenting the second level news events.

6. The method of claim 1, further comprising the step of receiving a query to present main news events relevant to the main subject, and
wherein said identifying and filtering steps are performed in response to receiving the query.

7. The method of claim 1, further comprising the step of filtering news events to identify main news events relevant to the main subject,
wherein said presenting step comprises presenting the main news events and the derivative news events.

8. The method of claim 7, wherein said presenting step further comprises simultaneously presenting the main news events and the derivative news events.

9. A computer-readable medium having computer-executable instructions for performing the computer-implemented method of claim 1.

10. A computer-implemented method for presenting derivative news events relevant to derivative entities of a main subject, comprising the steps of:
associating at least one derivative entity with the main subject based on a direct relationship between the at least one derivative entity and the main subject;
identifying the at least one derivative entity associated with the main subject;
receiving derivative news events relevant to the at least one derivative entity; and
presenting the derivative news events.

11. The method of claim 10, wherein the direct relationship between the at least one derivative entity and the main subject comprises one of supplier, customer, competitor, partner, joint venturer, and equity investor.

12. The method of claim 10, further comprising the step of filtering the derivative news events to identify filtered derivative news events based on one of the relationship between the at least one derivative entity and the main subject, an importance of the relationship between the at least one derivative entity and the main subject, and a percentage of the main subject's sales that is attributable to the at least one derivative entity,
wherein the derivative news events presented in said presenting step comprise only the filtered derivative news events.

13. The method of claim 10, further comprising the step of identifying an investment opportunity based on the presented derivative news events.

14. The method of claim 10, further comprising the steps of:
associating a second level derivative entity with the at least one derivative entity based on a direct relationship between the second level derivative entity and the at least one derivative entity; and
receiving second level news events relevant to the second level derivative entity,
wherein said presenting step further comprises presenting the second level news events.

15. The method of claim 10, further comprising the step of initiating a query to present main news events relevant to the main subject,
wherein said identifying and receiving steps are performed in response to initiating the query.

16. The method of claim 10, further comprising the step of receiving main news events relevant to the main subject,
wherein said presenting step comprises presenting the main news events and the derivative news events.

17. The method of claim 16, wherein said presenting step further comprises simultaneously presenting the main news events and the derivative news events.

18. The method of claim 16, further comprising the step of filtering non-specific news events to identify the main news events and the derivative news events.

19. A computer-readable medium having computer-executable instructions for performing the computer-implemented method of claim 10.

20. A system for presenting derivative news events relevant to derivative entities of a main subject, comprising:
a relationship database that associates a plurality of first level derivative entities with the main subject based on a direct relationship between each of the first level derivative entities and the main subject;
a workstation operable to communicate a query to receive main news events relevant to the main subject and to receive the main news events communicated in response to the query; and
a server operable to identify the first level derivative entities associated with the main subject in said relationship database,
wherein said workstation is further operable to receive derivative news events relevant to the first level derivative entities identified by said server and to present the received derivative news events simultaneously with the received main news events.

21. The system of claim 20, wherein the direct relationship between each of the first level derivative entities and the main subject comprises one of supplier, customer, competitor, partner, joint venturer, and equity investor.

22. The system of claim 20, wherein said workstation is further operable to filter the received derivative news events based on a particular type of the direct relationship between the first level derivative entities and the main subject and to present only the derivative news events for first level derivative entities having the particular type of relationship with the main subject with the presented main news events.

23. The system of claim 20, wherein said database further associates an importance of the relationship between the first level derivative entities and the main subject with respective ones of the first level derivative entities and a percentage of the main subject's sales that is attributable to the first level derivative entities with respective ones of the first level derivative entities,
wherein said workstation is further operable to filter the received derivative news events to identify filtered derivative news events based on at least one of the particular type of relationship between the first level derivative entities and the main subject, the importance of the relationship between the first level derivative entities and the main subject, and the percentage of the main subject's sales that is attributable to the first level derivative entities, and
wherein the workstation presents only the filtered derivative news events with the main subject news events.

24. The system of claim 20, further comprising a news service provider that receives the query from said workstation, filters non-specific news events to identify the main subject news events in response to receiving the query, and communicates the main subject news events to said workstation.

25. The system of claim 24, wherein said news service provider further communicates an identity of the main subject to said server,
wherein said server identifies the derivative entities associated with the main subject in said relationship database in response to receiving the identity of the main subject communicated by said news service provider and is further operable to communicate an identification of the derivative entities to said news service provider, and
wherein said news service provider filters the non-specific news events to identify the derivative news events in response to receiving the identification of the derivative entities communicated by said server and communicates the derivative news events to said workstation.

26. The system of claim 20, wherein said relationship database further associates respective ones of a plurality of second level derivative entities with corresponding first level derivative entities based on a direct relationship between the respective ones of the second level derivative entities and the corresponding first level derivative entities, and
wherein said workstation is further operable to receive and present second level derivative news events relevant to the second level derivative entities.
